(19) United States
(12) Patent Application Publication
(10) Pub. No.: US 2026/0289668 A1
(43) Pub. Date: Sep. 24, 2026

(54) INFORMATION PROCESSING DEVICE, INFORMATION PROCESSING METHOD, AND RECORDING MEDIUM

(71) Applicant: NEC Corporation, Tokyo (JP)

(72) Inventors: Iori TOKUDA, Tokyo (JP); Toshihiko FUJII, Tokyo (JP); Asako FUJII, Tokyo (JP)

(73) Assignee: NEC Corporation, Tokyo (JP)

(21) Appl. No.: 19/574,551

(22) Filed: Mar. 23, 2026

(30) Foreign Application Priority Data
Mar. 24, 2025 (JP) 2025-047666

(51) Int. Cl. G06Q 40/04

(52) U.S. Cl. CPC G06Q 40/04

(57) ABSTRACT

In an information processing device, A first acceptance means accepts input information on a search target. An inference means searches for information on the input information from among information on commodity classification, and infers an HS code candidate for the input information based on a result of the search. A determination means performs an applicability determination as to whether the HS code candidate is appropriate, based on the HS code candidate and an HS code inferred by a first language model.

### INCORPORATION BY REFERENCE

This application is based upon and claims the benefit of priority from Japanese patent application No. 2025-047666, filed on Mar. 24, 2025, the disclosure of which is incorporated herein in its entirety by reference.

### TECHNICAL FIELD

The present disclosure relates to a technology for determining tariff codes.

### BACKGROUND ART

A unique classification code (an HS code) is required to be assigned when importing and exporting commodities. The HS codes are universal classification codes in international trade, which are used for determining customs tariffs for commodities and the like. For example, Patent Document 1 proposes a machine learning model that predicts HS codes of commodities.

Patent Document 1: JP 2022-502744 A

### SUMMARY

The method of Patent Document 1 may, however, take time to predict the HS code.

An object of the present disclosure is to provide an information processing device capable of shortening time and securing accuracy in specifying HS codes.

According to an example aspect of the present invention, there is provided an information processing device, including:
at least one memory configured to store instructions; and
at least one processor configured to execute the instructions to:
accept, via a communication interface, input information on a search target transmitted from a terminal device over a network;
convert the input information into a vector;
perform a similarity search of a database storing information on commodity classification and vectorized information on commodity classification, based on the vector of the input information, and acquire information on commodity classification similar to the input information;
excerpt customs tariff schedules based on the acquired information on commodity classification;
generate, using a language model, an HS code candidate and a basis for the HS code candidate based on the input information, the excerpted customs tariff schedules, and the acquired information on commodity classification; and
perform an applicability determination as to whether the HS code candidate is appropriate, by inferring an HS code in consideration of the input information, the HS code candidate, and customs website information, and determining whether the HS code candidate matches the inferred HS code.

According to another example aspect of the present invention, there is provided an information processing method including:
accepting, via a communication interface, input information on a search target transmitted from a terminal device over a network;
converting the input information into a vector;
performing a similarity search of a database storing information on commodity classification and vectorized information on commodity classification, based on the vector of the input information, and acquiring information on commodity classification similar to the input information;
excerpting customs tariff schedules based on the acquired information on commodity classification;
generating, using a language model, an HS code candidate and a basis for the HS code candidate based on the input information, the excerpted customs tariff schedules, and the acquired information on commodity classification; and
performing an applicability determination as to whether the HS code candidate is appropriate, by inferring an HS code in consideration of the input information, the HS code candidate, and customs website information, and determining whether the HS code candidate matches the inferred HS code.

According to a further example aspect of the present invention, there is provided a recording medium recording a program for causing a computer to execute processing including:
accepting, via a communication interface, input information on a search target transmitted from a terminal device over a network;
converting the input information into a vector;
performing a similarity search of a database storing information on commodity classification and vectorized information on commodity classification, based on the vector of the input information, and acquiring information on commodity classification similar to the input information;
excerpting customs tariff schedules based on the acquired information on commodity classification;
generating, using a language model, an HS code candidate and a basis for the HS code candidate based on the input information, the excerpted customs tariff schedules, and the acquired information on commodity classification; and
performing an applicability determination as to whether the HS code candidate is appropriate, by inferring an HS code in consideration of the input information, the HS code candidate, and customs website information, and determining whether the HS code candidate matches the inferred HS code.

The present disclosure can provide an information processing device capable of shortening time and securing accuracy in specifying HS codes.

### BRIEF DESCRIPTION OF THE DRAWINGS

FIG. 1 illustrates an overall configuration of an HS code identification system to which an information processing device according to the present disclosure is applied;

FIG. 2 is an explanatory diagram of an HS code;

FIG. 3 is a block diagram illustrating a hardware configuration of the information processing device according to the present disclosure;

FIG. 4 is a block diagram illustrating a functional configuration of the information processing device according to the present disclosure;

FIG. 5 is an example of a template;

FIGS. 6A and 6B are examples of LLM responses;

FIGS. 7A and 7B illustrate a display example on a terminal device;

FIGS. 8A and 8B indicate examples of a template and a prompt;

FIG. 9 is a flowchart of processing performed by the information processing device according to the present disclosure;

FIG. 10 is a block diagram illustrating a functional configuration of another information processing device according to the present disclosure; and

FIG. 11 is a flowchart of processing performed by the another information processing device according to the present disclosure.

### EXAMPLE EMBODIMENT

Hereinafter, preferred example embodiments of the present disclosure will be described with reference to the drawings.

### First Example Embodiment

### [Entire Configuration]

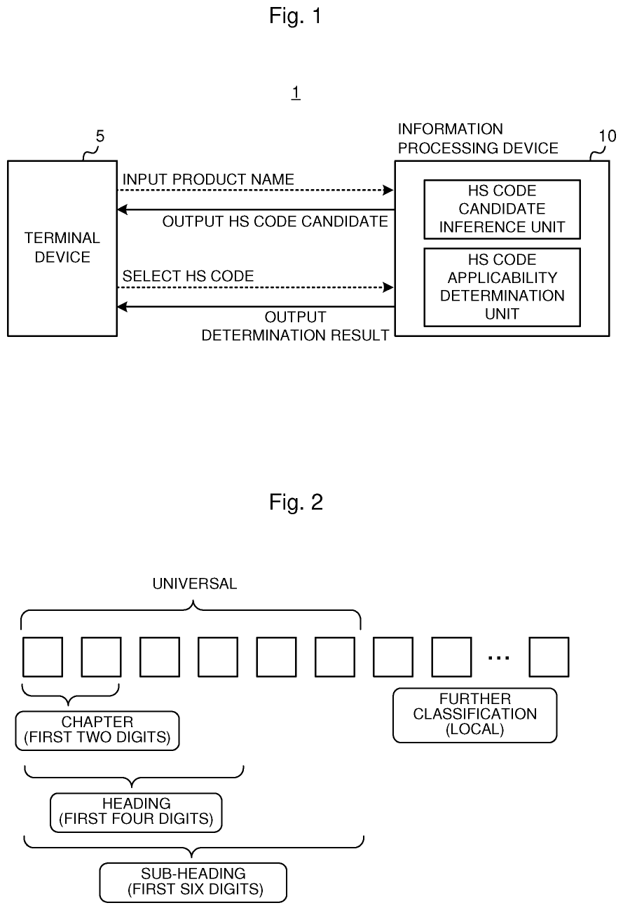

FIG. 1 illustrates an overall configuration of an HS code identification system to which an information processing device according to the present disclosure is applied. An HS code identification system 1 includes a terminal device 5 and an information processing device 10.

The terminal device 5 is operated by a user, such as a customs officer or a salesperson. The terminal device 5 includes, for example, a personal computer, a tablet terminal, or the like. The terminal device 5 communicates with the information processing device 10 through a network such as the Internet. In a case where the user wants to know an HS code of a certain products, the user operates the terminal device 5 to transmit a name of the products to the information processing device 10.

The information processing device 10 includes, for example, a server device and the like. The information processing device 10 communicates with the terminal device 5 through a network such as the Internet. The information processing device 10 includes an HS code candidate inference unit and an HS code applicability determination unit. The HS code candidate inference unit infers a candidate(s) of the HS code for the product name and transmits the candidate to the terminal device 5. The HS code applicability determination unit determines in detail whether the candidate of the HS code is appropriate, and transmits a determination result to the terminal device 5.

The HS code candidate inference unit roughly infers the candidate(s) of the HS code with emphasis on a processing speed, and the HS code applicability determination unit determines the candidate of the HS code in detail with emphasis on accuracy, which will be described later in detail. The information processing device 10 can thus shorten time and secure accuracy in specifying the HS code.

### [Description of HS Code]

Next, the HS code will be described. FIG. 2 is an explanatory diagram of the HS code. The harmonized system code (the HS code) is a code number defined based on the International Convention on the Harmonized Commodity Description and Coding System. The HS code broadly categorizes trade subject goods into 21 “sections”. The HS code is represented by digits equal to or more than 6 digits. The numbers up to six digits are universally used numbers, and each country may add any number of digits for the numbers after the six digits. Of the six digits, the first two digits are referred to as a chapter, the first four digits including the chapter are referred to as a heading, and the first six digits including the heading are referred to as a sub-heading. FIG. 2 describes an example in which the HS code is represented by a 9-digit number. For example, the first nine digits including the sub-heading are referred to as a subdivision. The present example embodiment will be described using an example for searching for a 9-digit HS code.

The HS code can be obtained from export statistical schedules and import statistical schedules (customs tariff schedules) published on the customs website (https://www. customs.go.jp/). When examining the HS code, notes to the chapter (hereinafter, also referred to as “chapter notes”), explanatory notes to the customs tariff schedule, classification opinions, and the like can be considered, in addition to the statistical schedules described above. The chapter notes, the explanatory notes to the customs tariff schedule, and the classification opinions are disclosed on the customs website. Information published on the customs website is an example of information on commodity classification.

### [Hardware Configuration]

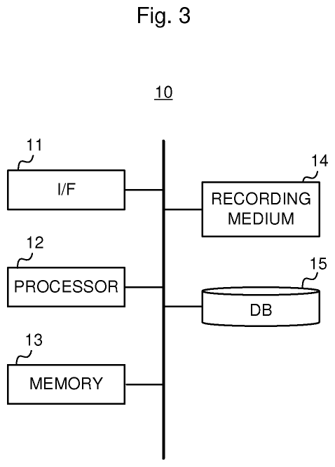

FIG. 3 is a block diagram illustrating a hardware configuration of the information processing device 10 according to the first example embodiment. As illustrated in the drawing, the information processing device 10 includes an interface (I/F) 11, a processor 12, a memory 13, a recording medium 14, and a database (DB) 15.

The I/F 11 communicates with the terminal device 5 through a network such as the Internet.

The processor 12 is a computer such as a central processing unit (CPU), and takes overall control of the information processing device 10 by executing a program prepared in advance. The processor 12 may be a graphics processing unit (GPU), a digital signal processor (DSP), a micro processing unit (MPU), a floating point unit (FPU), a physics processing unit (PPU), a tensor processing unit (TPU), a quantum processor, a microcontroller, or a combination thereof. The processor 12 executes HS code identification processing to be described later.

The memory 13 includes, for example, a read only memory (ROM) and a random access memory (RAM). The memory 13 is also used as a work memory during execution of various types of processing by the processor 12.

The recording medium 14 is a non-volatile non-transitory recording medium, such as a disk-shaped recording medium, a semiconductor memory, or the like, and is detachable from the information processing device 10. The recording medium 14 records various programs executed by the processor 12. In a case where the information processing device 10 executes various types of processing, a program recorded in the recording medium 14 is loaded into the memory 13 and is executed by the processor 12.

The DB 15 stores information disclosed by the customs, such as the export statistical schedules, the customs tariff schedules, the chapter notes, the explanatory notes to the customs tariff schedule, the classification opinions, and the like. The information described above is stored in the DB 15 after being converted into a text by an optical character recognition technology or the like, or after being converted into a vector by an embedding model or the like.

In addition to the above, the information processing device 10 may include a display device such as a liquid crystal display and an input device such as a keyboard or a mouse. The display device and the input device are used by an administrator of the information processing device 10 to perform necessary management, for example.

### [Functional Configuration]

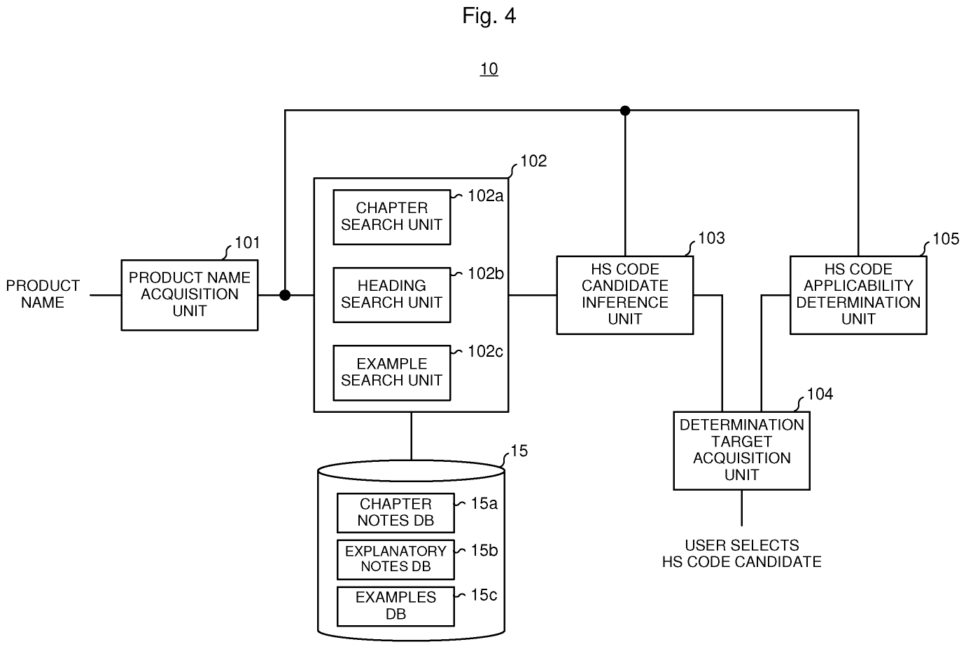

FIG. 4 is a block diagram illustrating a functional configuration of the information processing device 10 according to the first example embodiment. The information processing device 10 functionally includes a product name acquisition unit 101, a similarity search unit 102, an HS code candidate inference unit 103, a determination target acquisition unit 104, an HS code applicability determination unit 105, a chapter notes DB 15a, a explanatory notes DB 15b, and a examples DB 15c.

The product name acquisition unit 101, the similarity search unit 102, the HS code candidate inference unit 103, the determination target acquisition unit 104, and the HS code applicability determination unit 105 are constituted by the processor 12 illustrated in FIG. 3. The chapter notes DB 15a, the explanatory notes DB 15b, and the examples DB 15c are achieved by the DB 15 illustrated in FIG. 3.

A product name is input to the information processing device 10 from the terminal device 5 through the I/F 11. The product name is, for example, the name of a product such as “document file” or “fin of ray”. The product name is input to the product name acquisition unit 101. The product name acquisition unit 101 outputs the product name to the similarity search unit 102, the HS code candidate inference unit 103, and the HS code applicability determination unit 105.

The similarity search unit 102 includes a chapter search unit 102a, a heading search unit 102b, and an example search unit 102c.

The chapter search unit 102a searches the chapter notes DB 15a for a chapter note similar to the product name, and acquires a “chapter” associated to the chapter note. The chapter notes DB 15a is a vector DB and stores chapters, chapter notes associated to the chapters, and vectorized chapter notes in association with each other. The chapter notes refer to the chapter notes published on the customs website. Chapters (e.g., “chapter 2”), titles of the chapters (e.g., “meat and edible offal”), and descriptions of the chapters are described in the chapter notes.

Specifically, the chapter search unit 102a converts the product name into a vector, and calculates a similarity between the vector of the product name and the vector of the chapter note stored in the chapter notes DB 15a. For example, a cosine similarity or a Euclidean distance is used as the similarity. The chapter search unit 102a selects a predetermined number of chapter notes in descending order of the similarity, and acquires chapters associated to the selected chapter notes (hereinafter, also referred to as a “chapter number list”). The chapter search unit 102a outputs the chapter number list to the HS code candidate inference unit 103.

The heading search unit 102b searches the explanatory notes DB 15b for an explanatory note similar to the product name, and acquires a “heading” associated to the explanatory note. The explanatory notes DB 15b is a vector DB and stores headings, explanatory notes associated to the headings, and vectorized explanatory notes in association with each other. The explanatory note refers to the explanatory notes to the customs tariff schedule published on the customs website. Headings (e.g., “02.01”), titles of the headings (e.g., “beef (limited to fresh and refrigerated products)”), and explanatory notes of the headings are described in the explanatory notes to the customs tariff schedule. Product names associated to the “sub-headings”, which are a hierarchy under each heading, are described in the explanatory notes to the customs tariff schedule.

Specifically, the heading search unit 102b converts the product name into a vector, and calculates a similarity between the vector of the product name and the vector of the explanatory note stored in the explanatory notes DB 15b. For example, a cosine similarity or a Euclidean distance is used as the similarity. The heading search unit 102b selects a predetermined number of explanatory notes in descending order of the similarity, and acquires a heading associated to the selected explanatory note (hereinafter, also referred to as a “heading number list”). The heading search unit 102b outputs the heading number list to the HS code candidate inference unit 103.

The example search unit 102c searches the examples DB 15c for a example similar to the product name, and acquires a “sub-heading” associated to the example. The examples DB 15c is a vector DB and stores sub-headings, examples associated to the sub-headings, and vectorized examples in association with each other. The examples refer to the classification opinions published on the customs website. Sub-headings (e.g., “0303.82”) and examples of the product name associated to the sub-headings (e.g., “ray fins”) are described in the classification opinions.

Specifically, the example search unit 102c converts the product name into a vector, and calculates a similarity between the vector of the product name and the vector of the example stored in the examples DB 15c. For example, a cosine similarity or a Euclidean distance is used as the similarity. In a case where there is a example whose similarity is equal to or more than a predetermined threshold value, the example search unit 102c acquires a sub-heading associated to the example (hereinafter, also referred to as a “similar example”). The example search unit 102c then outputs the similar example to the HS code candidate inference unit 103. The example search unit 102c outputs no similar example to the HS code candidate inference unit 103 in a case where there is no example whose similarity is equal to or more than the predetermined threshold.

Text-embedding provided by OpenAI is used for embedding processing (a vector conversion) of the chapter notes, the explanatory notes, the examples, and the product names. The embedding processing may be performed using methods such as word2vec, global vectors (GloVe), and bidirectional encoder representations from transformers (BERT), in addition to the method described above. The chapter note, the explanatory note, and the example may be divided into multiple portions (chunks) in such a way as to have a length within a predetermined range as necessary, and the embedding processing may be performed on each chunk. In this example, the chapter notes DB 15a, the explanatory notes DB 15b, and the examples DB 15c store chunks and vectorized chunks in association with each other.

The product name is input to the HS code candidate inference unit 103 from the product name acquisition unit 101, and the chapter number list, the heading number list, and the similar examples are input to the HS code candidate inference unit 103 from the similarity search unit 102.

First, the HS code candidate inference unit 103 excerpts statistical schedules based on the chapter number list and the heading number list. The present example embodiment uses the import statistical schedules (the customs tariff schedules) as the statistical schedules. The customs tariff schedule is collected for each chapter, and the HS code and the product name represented by the HS code are described in association with each other. The HS code candidate inference unit 103 collates the chapters included in the chapter number list and the heading number list with the customs tariff schedule, and excerpts a portion associated to the chapters. For example, in a case where the chapter number list includes three chapters of “01”, “09”, and “19”, and the heading number list includes three headings of “02.01”, “09.01”, and “19.01”, the HS code candidate inference unit 103 excerpts customs tariff schedules of four chapters of “01”, “02”, “09”, and “19” from the customs tariff schedule.

Next, the HS code candidate inference unit 103 infers a candidate(s) of the HS code and its basis, based on the product name and the excerpted customs tariff schedules. In a case where there is a similar example, the HS code candidate inference unit 103 performs inference, including inferring similar examples.

Specifically, the HS code candidate inference unit 103 uses a language model to infer one or more candidates of the HS code and its basis. First, the HS code candidate inference unit 103 generates a prompt (a directive) to be input to the language model. The prompt includes an instruction to output the candidate(s) of the HS code and a basis for selecting the candidate(s), and information necessary for execution of a task (i.e., the product name, the excerpted customs tariff schedules, and the similar examples). For example, the HS code candidate inference unit 103 can generate a prompt by inserting the product name, the excerpted customs tariff schedules, and the similar examples into a template prepared in advance. The HS code candidate inference unit 103 then inputs the generated prompt to the language model and acquires a response from the language model. The response of the language model includes a candidate of the HS code for the product name and a basis for selecting the candidate. The HS code candidate inference unit 103 outputs the response of the language model to the determination target acquisition unit 104. Hereinafter, the candidate of the HS code is also referred to as an “HS code candidate”.

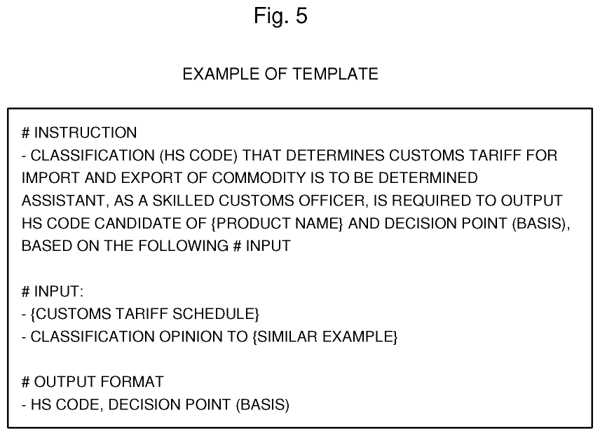

FIG. 5 is an example of a template. In FIG. 5, {product name}, {customs tariff schedule}, and {similar example} are insertion places to which a product name, an excerpted customs tariff schedule, and a similar example are inserted, respectively.

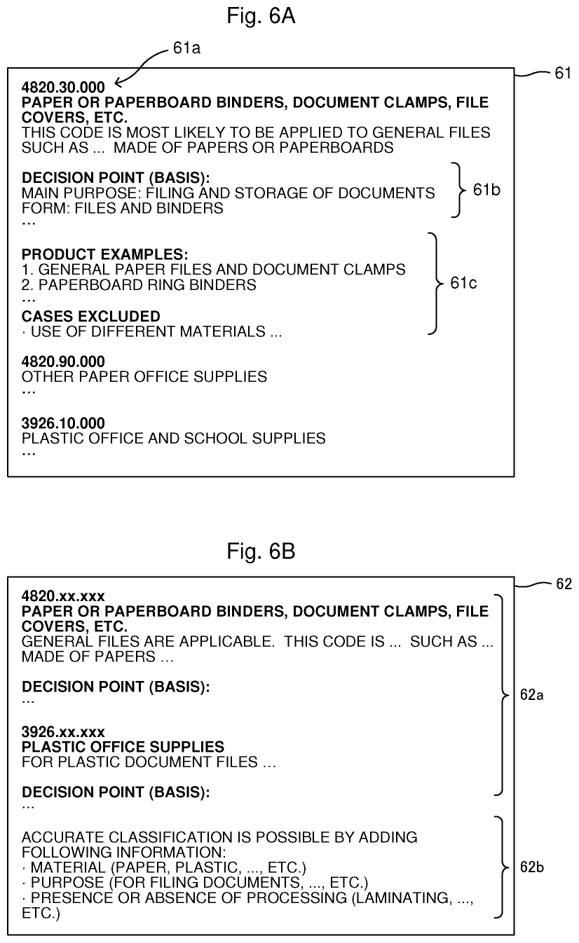

FIGS. 6A and 6B are examples of responses of a language model. A product name “document file” is inserted. A response example 61 in FIG. 6A includes an HS code 61a, a basis 61b, and detailed information 61c. The basis 61b indicates a basis of selecting the HS code 61a. The detailed information 61c indicates details of the HS code 61a, and “product examples” and “excluded examples” are illustrated in the example of FIG. 6A. The HS code candidate inference unit 103 can obtain the detailed information 61c by including in a prompt an instruction to output details (i.e., the product examples and the excluded examples). The response example 61 includes multiple HS code candidates, and a basis and detailed information are indicated for each HS code.

In a case where the information input by the user is insufficient, the HS code candidate inference unit 103 may cause the language model to output a message requesting additional information. FIG. 6B illustrates a response example from the language model in a case where the input information is insufficient. A response example 62 in FIG. 6B includes an HS code 62a and a message 62b. The HS code 62a is an HS code candidate. The example of FIG. 6B is short of input information, and a part of the HS code is represented by “x” in the language model. The message 62b is a message for requesting additional information. In the example of FIG. 6B, the message 62b is a message indicating information to be added. In a case where the input information is insufficient, the HS code candidate inference unit 103 can obtain the message 62b by including in the prompt an instruction to output information to be added. The user can know what kind of information should be added to the product name (e.g., “document file/paper” and the like) by such a message.

Here, the language model refers to a model of natural language processing trained using a large amount of text data, and uses a text as an input and outputs a result associated to the input text. The present example embodiment uses large language models (LLMs), such as generative pre-trained transformer (GPT). Specific LLMs used by the HS code candidate inference unit 103 and the HS code applicability determination unit 105 to be described later include GPT-4o and GPT-4o mini provided by OpenAI, for example. Hereinafter, the language model is also referred to as the “LLM”.

As described above, the similarity search unit 102 and the HS code candidate inference unit 103 according to the present example embodiment first narrow down the chapter associated to the product name by data search. The similarity search unit 102 and the HS code candidate inference unit 103 then input information on the narrowed down chapter to an LLM, and execute inference of the HS code candidate. The data search is completed in a short time, and therefore, the processing is faster than in a case where the LLM performs inference for all chapters.

Returning to FIG. 4, the determination target acquisition unit 104 generates display data based on the LLM response and transmits the display data to the terminal device 5. Specifically, the determination target acquisition unit 104 divides the LLM response for each HS code candidate, and generates display data including an evaluation button associated to each HS code candidate. The evaluation button is pressed in a case where it is desired to determine whether the HS code candidate is appropriate as the HS code for the product name.

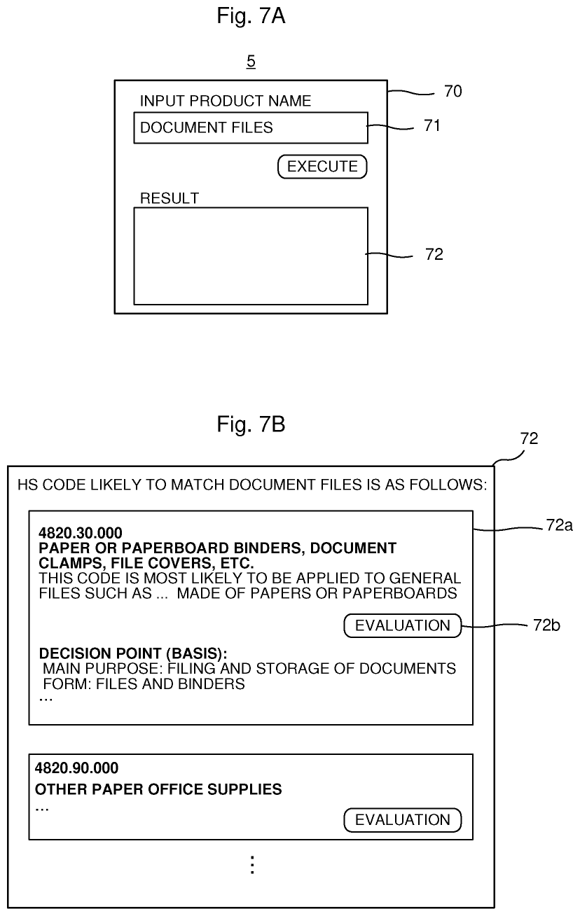

FIGS. 7A and 7B illustrate a display example on the terminal device 5. FIG. 7A illustrates a display screen displayed on the terminal device 5. The display screen 70 includes a product name input field 71 for inputting a product name, and a result display field 72 for displaying HS code candidates for the product name. In a case where the user inputs the product name in a product name input field 71 and presses an execution button, the display data generated by the determination target acquisition unit 104 is displayed in the result display field 72. FIG. 7B is a display example of the result display field 72. In the example of FIG. 7B, the result display field 72 includes an HS code candidate 72a and an evaluation button 72b. The user presses the evaluation button 72b in a case where it is desired to determine whether the HS code candidate indicated by the HS code candidate 72a, that is, (4820.30.000), is appropriate.

Returning to FIG. 4, the user operates the terminal device 5 and presses the evaluation button of the HS code candidate. The determination target acquisition unit 104 acquires the HS code candidate selected by the user and outputs the HS code candidate to the HS code applicability determination unit 105.

The product name is input from the product name acquisition unit 101 to the HS code applicability determination unit 105, and the HS code candidate selected by the user is input from the determination target acquisition unit 104 to the HS code applicability determination unit 105.

The HS code applicability determination unit 105 performs an applicability determination for determining whether the HS code candidate is appropriate. First, the HS code applicability determination unit 105 infers an HS code for the product name in more detail in consideration of the product name, the HS code candidate, and various information published on the customs website (hereinafter, also referred to as “customs website information”). The customs website information includes, for example, chapter titles, heading titles, customs tariff schedules, chapter notes, explanatory notes to the customs tariff schedule, classification opinions, and the like. The HS code applicability determination unit 105 then determines whether the HS code candidate and the inferred HS code match with each other. In a case where the HS code candidate and the inferred HS code match with each other, the HS code applicability determination unit 105 determines that the HS code candidate is appropriate. In a case where the HS code candidate and the inferred HS code do not match with each other, on the other hand, the HS code applicability determination unit 105 determines that the HS code candidate is inappropriate. The HS code applicability determination unit 105 transmits a determination result to the terminal device 5.

An LLM is used to infer the HS code. First, the HS code applicability determination unit 105 generates a prompt to be input to the LLM. The prompt includes an instruction to output an HS code and information necessary for execution of the task (i.e., the product names and the customs website information). For example, the HS code applicability determination unit 105 can generate a prompt by inserting the product name and the HS code candidate into a template prepared in advance. The HS code applicability determination unit 105 then inputs the generated prompt to the LLM and causes the LLM to infer the HS code.

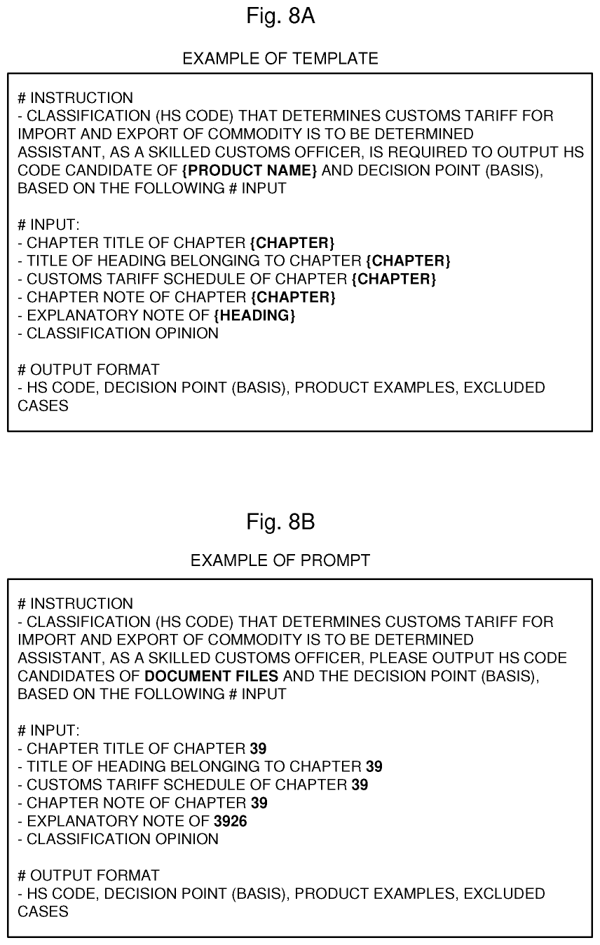

FIGS. 8A and 8B indicate examples of a template and a prompt. FIG. 8A is the example of the template. In FIG. 8A, {product name}, {chapter}, and {heading} indicate insertion portions. A product name is inserted in {product name}. A chapter of an HS code candidate is inserted in {chapter}. A heading of the HS code candidate is inserted in {heading}. For example, in a case where the product name input from the product name acquisition unit 101 is “document file” and the HS code candidate input from the determination target acquisition unit 104 is “3926.10.000”, the HS code applicability determination unit 105 can generate a prompt illustrated in FIG. 8B.

In a case where there are multiple HS code candidates, the user may press the evaluation buttons of multiple HS code candidates. Each time the evaluation button is pressed, the HS code applicability determination unit 105 performs an applicability determination for the HS code candidate and transmits the determination result to the terminal device 5.

In a case where the HS code applicability determination unit 105 determines that the HS code candidate is inappropriate, the HS code applicability determination unit 105 may infer the HS code again and transmit an inference result to the terminal device 5. At this time, the HS code applicability determination unit 105 inputs the product name and the customs website information of all chapters to the LLM, and causes the LLM to perform inference of the HS code.

As described above, the HS code applicability determination unit 105 of the present example embodiment infers the HS code with reference to various information published on the customs website. The HS code applicability determination unit 105 is thus capable of performing inference with higher accuracy than the HS code candidate inference unit 103.

In the configuration described above, the product name acquisition unit 101 is an example of a first acceptance means, the similarity search unit 102 and the HS code candidate inference unit 103 are examples of inference means, the determination target acquisition unit 104 is an example of a second acceptance means, the HS code applicability determination unit 105 is an example of a determination means, and the chapter notes DB 15a, the explanatory notes DB 15b, and the examples DB 15c are examples of a storage means. The product name input from the terminal device 5 is an example of input information on the search target.

### [Processing Flow]

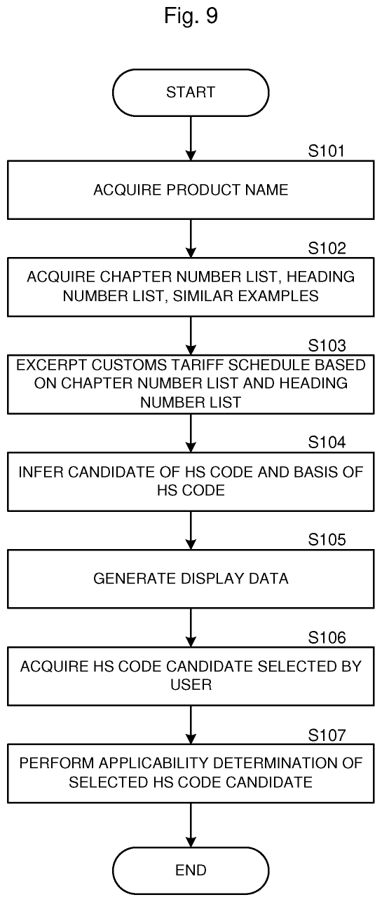

FIG. 9 is a flowchart of the HS code identification processing carried out by the information processing device 10. This processing is achieved by the processor 12 illustrated in FIG. 3 executing a program prepared in advance and operating as each element illustrated in FIG. 4.

First, a product name is input to the information processing device 10 from the terminal device 5 through the I/F 11. The product name is input to the product name acquisition unit 101 (Step S101). The product name acquisition unit 101 outputs the product name to the similarity search unit 102, the HS code candidate inference unit 103, and the HS code applicability determination unit 105.

Next, the similarity search unit 102 searches the DB 15 for information similar to the product name, and acquires a chapter number list, a heading number list, and similar examples (Step S102). The similarity search unit 102 outputs the chapter number list, the heading number list, and the similar examples to the HS code candidate inference unit 103.

Next, the HS code candidate inference unit 103 excerpts customs tariff schedules based on the chapter number list and the heading number list (Step S103). Next, the HS code candidate inference unit 103 infers a candidate of an HS code and its basis, based on the product name, the excerpted customs tariff schedules, and the similar examples (Step S104). Specifically, the HS code candidate inference unit 103 inputs to an LLM a prompt including an instruction to output a candidate of the HS code and a basis for selecting the candidate and information necessary for execution of the task (i.e., the product name, the excerpted customs tariff schedules, and the similar examples), and acquires a response from the LLM. The HS code candidate inference unit 103 outputs the response from the LLM to the determination target acquisition unit 104.

Next, the determination target acquisition unit 104 generates display data including the HS code candidate and the evaluation button, and transmits the display data to the terminal device 5 (Step S105). Next, the determination target acquisition unit 104 acquires the HS code candidate selected by the user from the terminal device 5 (Step S106). The determination target acquisition unit 104 outputs the selected HS code candidate to the HS code applicability determination unit 105.

Next, the HS code applicability determination unit 105 performs an applicability determination for determining whether the selected HS code candidate is appropriate (Step S107). Specifically, the HS code applicability determination unit 105 infers the HS code for the product name in more detail in consideration of the product name, the HS code candidate, and the customs website information. The HS code applicability determination unit 105 then determines whether the HS code candidate and the inferred HS code match with each other, and transmits a determination result to the terminal device 5. Then, the processing ends.

### Second Example Embodiment

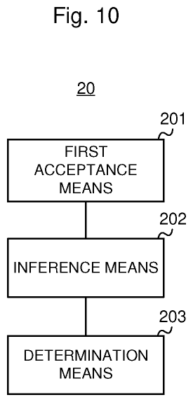

FIG. 10 is a block diagram illustrating a functional configuration of an information processing device according to a second example embodiment. An information processing device 20 includes a first acceptance means 201, an inference means 202, and a determination means 203.

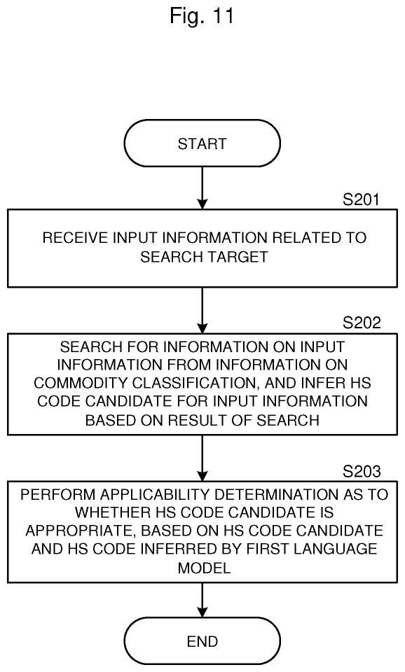

FIG. 11 is a flowchart of processing performed by the information processing device according to the second example embodiment. The first acceptance means 201 accepts input information on a search target (Step S201). The inference means 202 searches for information on the input information from among information on commodity classification, and infers an HS code candidate for the input information based on a result of the search (Step S202). The determination means 203 performs an applicability determination as to whether the HS code candidate is appropriate, based on the HS code candidate and an HS code inferred by a first language model (Step S203).

The information processing device 20 of the second example embodiment is capable of shortening time and securing accuracy in specifying HS codes.

Some or all of the above example embodiments may be described as the following Supplementary Notes, but are not limited to the following.

### (Supplementary Note 1)

An information processing device including:
a first acceptance means for accepting input information on a search target;
an inference means for searching for information on the input information from among information on commodity classification, and inferring an HS code candidate for the input information based on a result of the search; and
a determination means for performing an applicability determination as to whether the HS code candidate is appropriate, based on the HS code candidate and an HS code inferred by a first language model.

### (Supplementary Note 2)

The information processing device according to supplementary note 1 including
a second acceptance means for accepting selection of an HS code candidate for which an applicability determination is to be made, from among the HS code candidates inferred by the inference means,
wherein
the determination means performs the applicability determination of the selected HS code candidate.

### (Supplementary Note 3)

The information processing device according to supplementary note 1 including
a storage means for storing a number associated with the information on commodity classification, the information on commodity classification, and the information on commodity classification vectorized,
wherein
the inference means performs search using similarity between the input information vectorized and the information on commodity classification vectorized in the storage means.

### (Supplementary Note 4)

The information processing device according to supplementary note 3, wherein
the information on commodity classification includes a chapter note, an explanatory note to a customs tariff schedule, and a classification opinion,
the number associated with the information on commodity classification includes a chapter, a heading, and a sub-heading, and
the inference means searches for a chapter related to the input information based on a similarity between the input information and the chapter note, searches for a heading related to the input information based on a similarity between the input information and the explanatory note to the customs tariff schedule, and searches for a sub-heading related to the input information based on a similarity between the input information and the classification opinion.

### (Supplementary Note 5)

The information processing device according to supplementary note 4, wherein
the inference means excerpts predetermined information from statistical schedules based on a chapter and a heading related to the input information, inputs a prompt including the input information, the excerpted information, and an instruction to infer an HS code candidate to a second language model, and acquires an HS code candidate from the second language model.

### (Supplementary Note 6)

The information processing device according to supplementary note 5, wherein
the inference means includes a sub-heading related to the input information in the prompt in a case where the sub-heading is searched.

### (Supplementary Note 7)

The information processing device according to supplementary note 2, wherein
the determination means generates a prompt based on the input information and the HS code candidate,
the prompt includes an instruction to infer an HS code for the input information with reference to information on the HS code candidate from among the information on commodity classification, and
the first language model uses the prompt as an input and infers the HS code.

### (Supplementary Note 8)

The information processing device according to supplementary note 7, wherein
in a case where the determination means determines that the HS code candidate is inappropriate, the determination means instructs the first language model to infer an HS code with reference to all the information on commodity classification.

### (Supplementary Note 9)

An information processing method performed by a computer, the method including:
accepting input information on a search target;
searching for information on the input information from information on commodity classification, and inferring an HS code candidate for the input information based on a result of the search; and
performing an applicability determination as to whether the HS code candidate is appropriate, based on the HS code candidate and an HS code inferred by a first language model.

### (Supplementary Note 10)

A program for causing a computer to perform processing including:
accepting input information on a search target;
searching for information on the input information from information on commodity classification, and inferring an HS code candidate for the input information based on a result of the search; and
performing an applicability determination as to whether the HS code candidate is appropriate, based on the HS code candidate and an HS code inferred by a first language model.

While the present disclosure has been described with reference to example embodiments and examples thereof, the present disclosure is not limited to the example embodiments and examples described above. It will be understood by those of ordinary skill in the art that various changes in form and details may be made therein without departing from the spirit and scope of the present disclosure as defined by the claims.

### DESCRIPTION OF SYMBOLS

1 HS code identification system
5 terminal device
10 information processing device
15 database (DB)
15a chapter notes DB
15b explanatory notes DB
15c examples DB
101 product name acquisition unit
102 similarity search unit
103 HS code candidate inference unit
104 determination target acquisition unit
105 HS code applicability determination unit

1. An information processing device comprising:
at least one memory configured to store instructions; and
at least one processor configured to execute the instructions to:
accept, via a communication interface, input information on a search target transmitted from a terminal device over a network;
convert the input information into a vector;
perform a similarity search of a database storing information on commodity classification and vectorized information on commodity classification, based on the vector of the input information, and acquire information on commodity classification similar to the input information;
excerpt customs tariff schedules based on the acquired information on commodity classification;
generate, using a first language model, an HS code candidate and a basis for the HS code candidate based on the input information, the excerpted customs tariff schedules, and the acquired information on commodity classification; and
perform an applicability determination as to whether the HS code candidate is appropriate, by inferring an HS code in consideration of the input information, the HS code candidate, and customs website information, and determining whether the HS code candidate matches the inferred HS code.

2. The information processing device according to claim 1, the one or more processors are further configured to accept selection of an HS code candidate for which an applicability determination is to be made, from among the HS code candidates, wherein
the one or more processors perform the applicability determination of the selected HS code candidate.

3. The information processing device according to claim 1, wherein
the one or more processors store a number associated with the information on commodity classification, the information on commodity classification, and the information on commodity classification vectorized in a database,
the one or more processors perform search using similarity between the input information vectorized and the information on commodity classification vectorized in the database.

4. The information processing device according to claim 3, wherein
the information on commodity classification includes a chapter note, an explanatory note to a customs tariff schedule, and a classification opinion,
the number associated with the information on commodity classification includes a chapter, a heading, and a sub-heading, and
the one or more processors search for a chapter related to the input information based on a similarity between the input information and the chapter note, search for a heading related to the input information based on a similarity between the input information and the explanatory note to the customs tariff schedule, and search for a sub-heading related to the input information based on a similarity between the input information and the classification opinion.

5. The information processing device according to claim 4, wherein
the one or more processors excerpt predetermined information from statistical schedules based on a chapter and a heading related to the input information, input a prompt including the input information, the excerpted information, and an instruction to infer an HS code candidate to the first language model, and acquire an HS code candidate from the first language model.

6. The information processing device according to claim 5, wherein
the one or more processors include a sub-heading related to the input information in the prompt in a case where the sub-heading is searched.

7. The information processing device according to claim 2, wherein
the one or more processors generate a prompt based on the input information and the HS code candidate,
the prompt includes an instruction to infer an HS code for the input information with reference to information on the HS code candidate from among the information on commodity classification, and
the one or more processors input the prompt into a second language model and infer the HS code.

8. The information processing device according to claim 7, wherein
in a case where the one or more processors determine that the HS code candidate is inappropriate, the one or more processors instruct the second language model to infer an HS code with reference to all the information on commodity classification.

9. An information processing method performed by a computer, the method comprising:
accepting, via a communication interface, input information on a search target transmitted from a terminal device over a network;
converting the input information into a vector;
performing a similarity search of a database storing information on commodity classification and vectorized information on commodity classification, based on the vector of the input information, and acquiring information on commodity classification similar to the input information;
excerpting customs tariff schedules based on the acquired information on commodity classification;
generating, using a language model, an HS code candidate and a basis for the HS code candidate based on the input information, the excerpted customs tariff schedules, and the acquired information on commodity classification; and
performing an applicability determination as to whether the HS code candidate is appropriate, by inferring an HS code in consideration of the input information, the HS code candidate, and customs website information, and determining whether the HS code candidate matches the inferred HS code.

10. A non-transitory computer readable recording medium recording a program for causing a computer to execute processing comprising:
accepting, via a communication interface, input information on a search target transmitted from a terminal device over a network;
converting the input information into a vector;
performing a similarity search of a database storing information on commodity classification and vectorized information on commodity classification, based on the vector of the input information, and acquiring information on commodity classification similar to the input information;
excerpting customs tariff schedules based on the acquired information on commodity classification;
generating, using a language model, an HS code candidate and a basis for the HS code candidate based on the input information, the excerpted customs tariff schedules, and the acquired information on commodity classification; and
performing an applicability determination as to whether the HS code candidate is appropriate, by inferring an HS code in consideration of the input information, the HS code candidate, and customs website information, and determining whether the HS code candidate matches the inferred HS code.
